(19) United States
(12) Patent Application Publication
(10) Pub. No.: US 2015/0096949 A1
(43) Pub. Date: Apr. 9, 2015

(54) MODULAR GARDEN SYSTEM

(71) Applicant: SHENG SAN CO., LTD., TAICHUNG CITY (TW)

(72) Inventor: Cheng-Chung CHANG, TAICHUNG CITY (TW)

(21) Appl. No.: 14/159,250

(22) Filed: Jan. 20, 2014

(30) Foreign Application Priority Data
Oct. 9, 2013 (TW) 102218934

(51) Int. Cl. A47B 87/00; A01G 9/12

(52) U.S. Cl. CPC A47B 87/008; A01G 9/12
USPC 211/85.23

(57) ABSTRACT

A modular garden system is provided with a rectangular frame including a plurality of rectangular openings spaced apart vertically; a plurality of hooks formed on one side of the frame, each hook including a vertical groove; a plurality of connectors formed on an other side of the frame, each connector including a post; a bar disposed on a top of the frame; and a hook member disposed on an underside of the frame, the hook member including a horizontal groove. The posts of one garden system are capable of being complimentarily received in the vertical grooves of the hooks of an adjacent garden system. The bar of one garden system is capable of being complimentarily received in the horizontal groove of the hook member of an adjacent garden system.

### BACKGROUND OF THE INVENTION

1. Field of the Invention

The invention relates to container gardening and more particularly to a modular garden system.

2. Description of Related Art

There is a conventional mounting assembly for affixing a planter to a vertical wall. The planter has a surrounding wall extending upwardly from a bottom, and an open top. The bottom is so configured as to accommodate at least one vertically oriented bolt. The bolt is isolated from the interior of the planter. At least one bracket is attachable to the planter by the bolt. The bracket is also attachable to the wall by appropriate fastening means. The planter bottom is provided with at least one upstanding socket for the bolt. The socket has a central vertical bore with an open bottom end and a closed top end. An internally threaded bushing is fixed in the socket bore to be threadedly secured to the bolt.

While it has some utility, improvements in these products are desired, and these improvements are provided by the invention.

### SUMMARY OF THE INVENTION

It is therefore one object of the invention to provide a modular garden system comprising a rectangular frame comprising a plurality of rectangular openings spaced apart vertically; a plurality of hooks formed on one side of the frame, each of the hooks comprising a vertical groove; a plurality of connectors formed on an other side of the frame, each of the connectors comprising a post; a bar disposed on a top of the frame; and a hook member disposed on an underside of the frame, the hook member comprising a horizontal groove; wherein the posts of one garden system are capable of being complimentarily received in the vertical grooves of the hooks of an adjacent garden system; and wherein the bar of one garden system is capable of being complimentarily received in the horizontal groove of the hook member of an adjacent garden system.

The above and other objects, features and advantages of the invention will become apparent from the following detailed description taken with the accompanying drawings.

### BRIEF DESCRIPTION OF THE DRAWINGS

FIG. 1 is a perspective view of a modular garden system according to the invention;

FIG. 2 is a greatly enlarged view of an upper portion of the garden system;

FIG. 3 is a greatly enlarged view of a lower portion of the garden system;

FIG. 4 is a perspective view of two transversely assembled garden systems;

FIG. 5 is a sectional view taken along line 5-5 of FIG. 4;

FIG. 6 is a fragmentary view of two longitudinally assembled garden systems;

FIG. 7 is a sectional view taken along line 7-7 of FIG. 6;

FIG. 8 is a perspective view of four transversely assembled garden systems with flowerpots secured thereon; and

FIG. 9 is a perspective view of six transversely assembled garden systems forming a hexagonal structure with plants placed in the flowerpot.

### DETAILED DESCRIPTION OF THE INVENTION

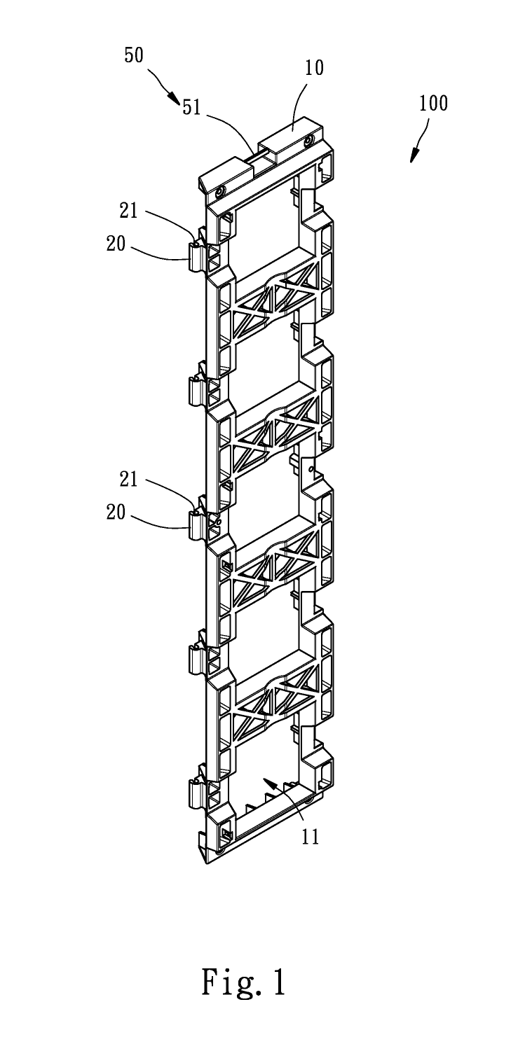

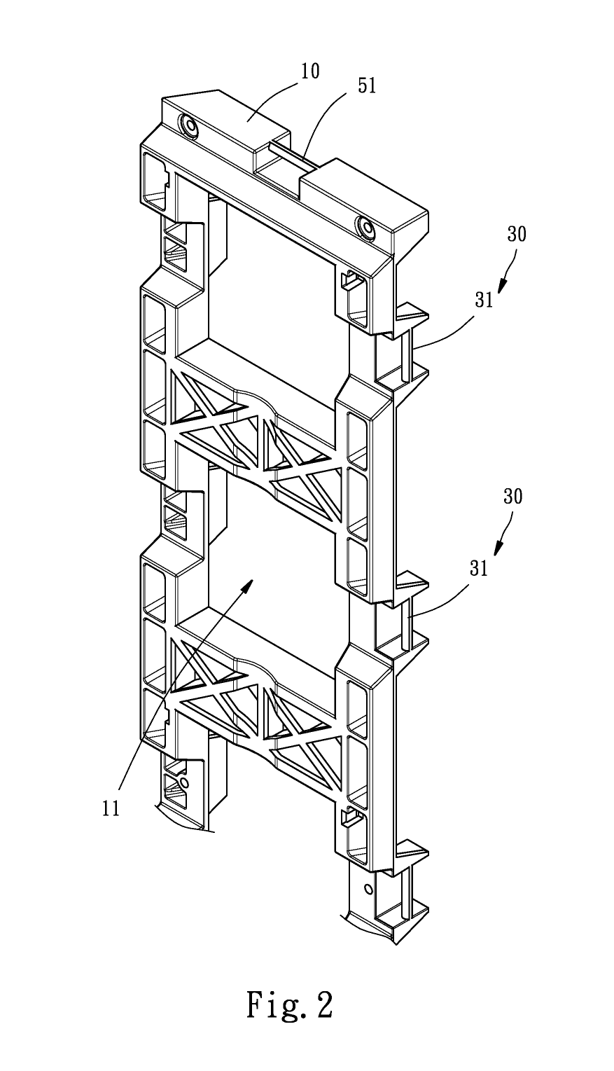

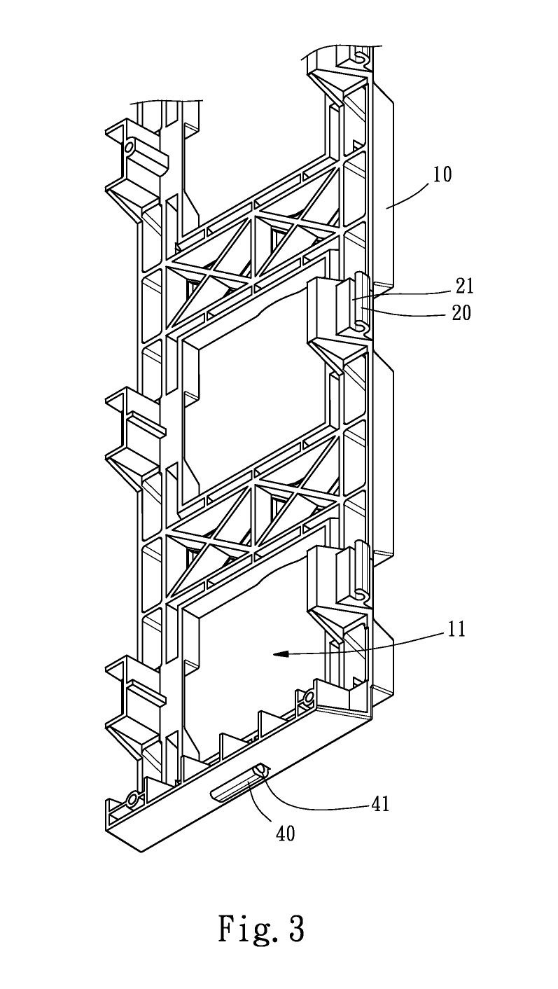

Referring to FIGS. 1 to 9, a modular garden system 100 in accordance with the invention is rectangular and comprises the following components as discussed in detail below.

A rectangular frame 10 is made of plastic and comprises a plurality of rectangular openings 11 spaced apart vertically. A plurality of hooks 20 are spaced apart on one side of the frame 10 and each hook 20 comprises a vertical groove 21 having a vertical narrow opening. A plurality of connectors 30 are spaced apart on the other side of the frame 10 and each connector 30 comprises a post 31. A bar 51 is provided on an intermediate portion of a top of the frame 10. A hook member 40 is provided on an intermediate portion of an underside of the frame 10 and each hook member 40 comprises a horizontal groove 41 having a horizontal narrow opening.

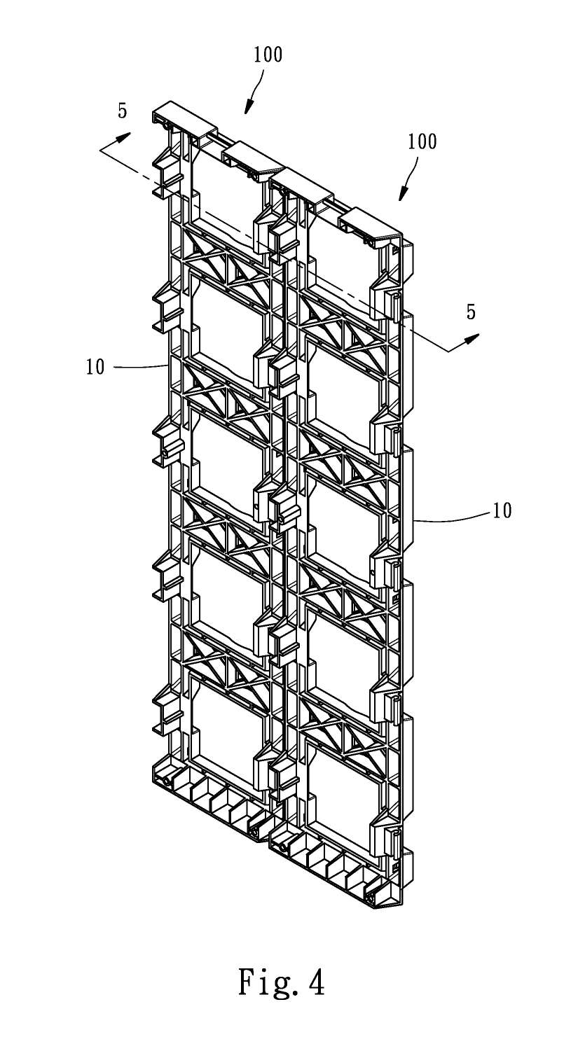

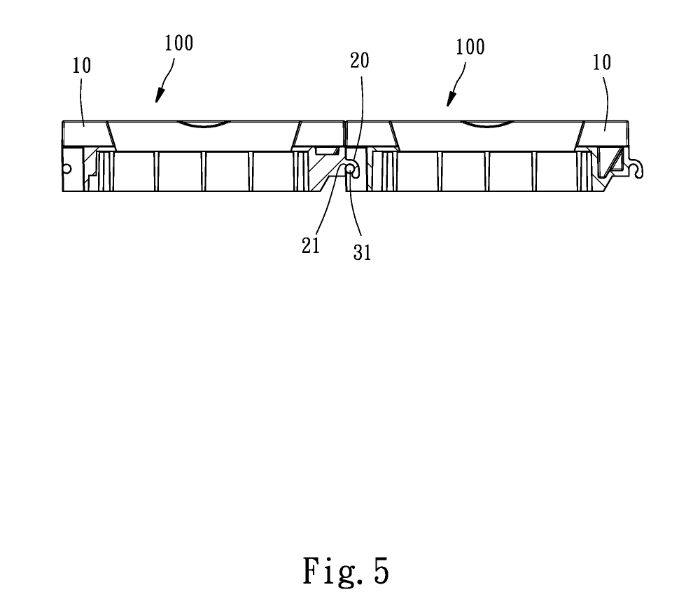

In a state of two transversely assembled garden systems 100 (see FIGS. 4 and 5), the posts 31 of the connectors 30 of one garden system 100 are complimentarily received in the vertical grooves 21 of the hooks 20 of the other garden system 100 by pressing.

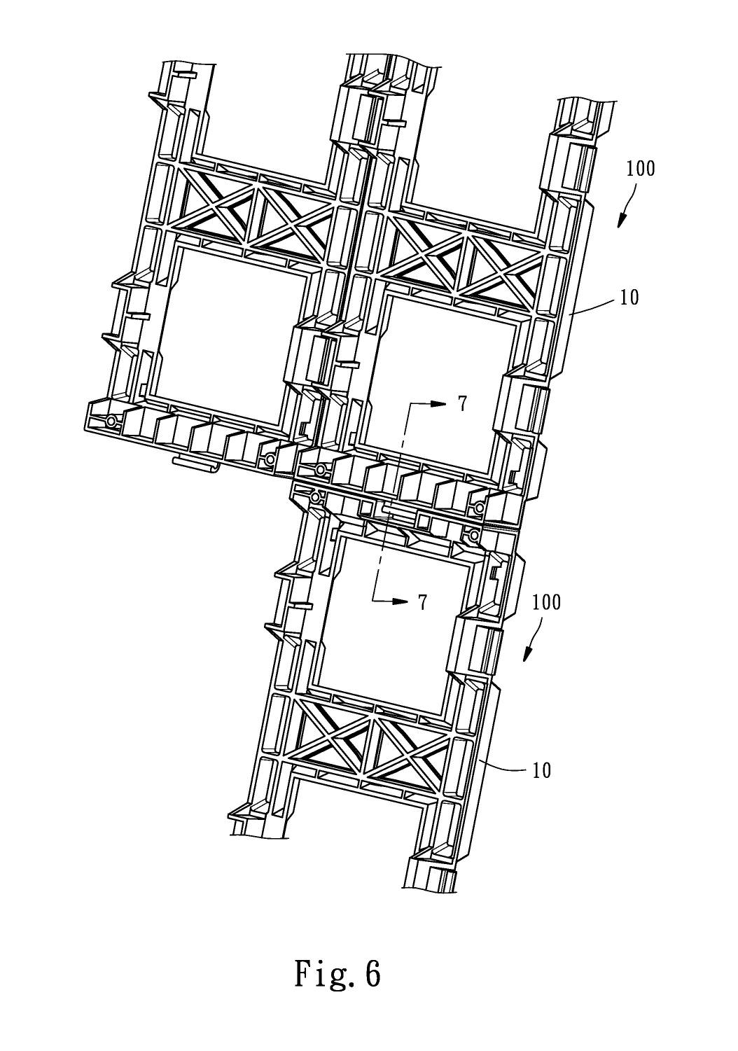

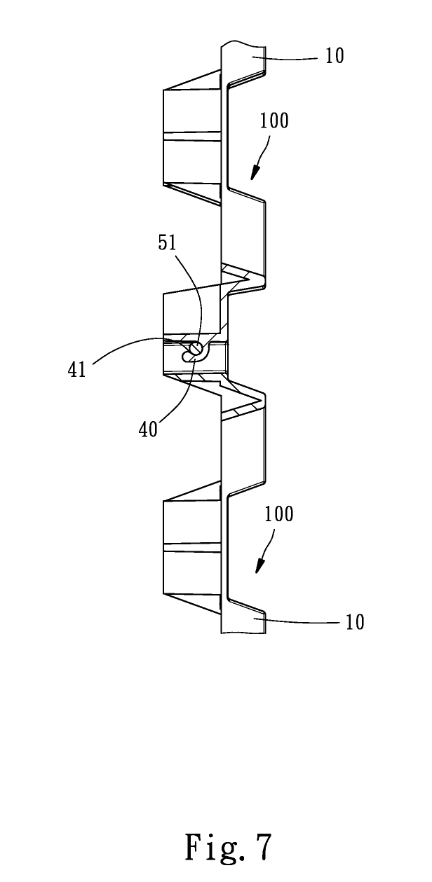

In a state of two longitudinally assembled garden systems 100 (see FIGS. 6 and 7), the bar 51 of one garden system 100 is complimentarily received in the horizontal groove 41 of the other garden system 100 by pressing.

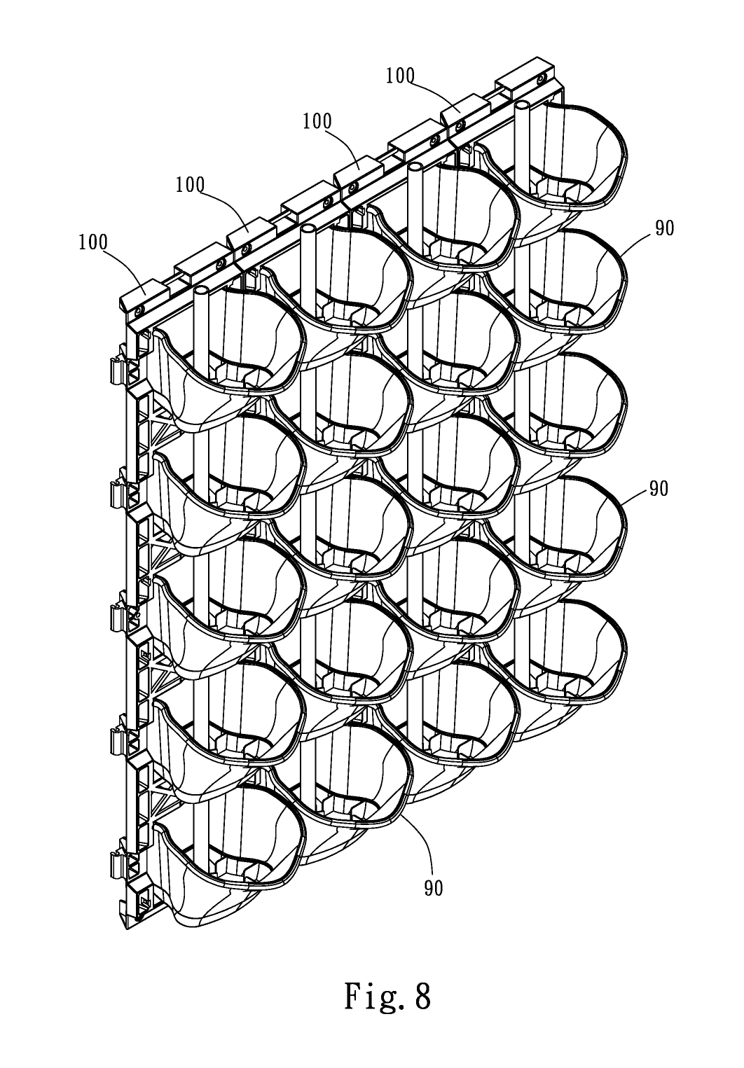

The garden systems 100 can be assembled transversely with a plurality of flowerpots 90 hanged on a transverse member between two adjacent openings 11 (see FIG. 8).

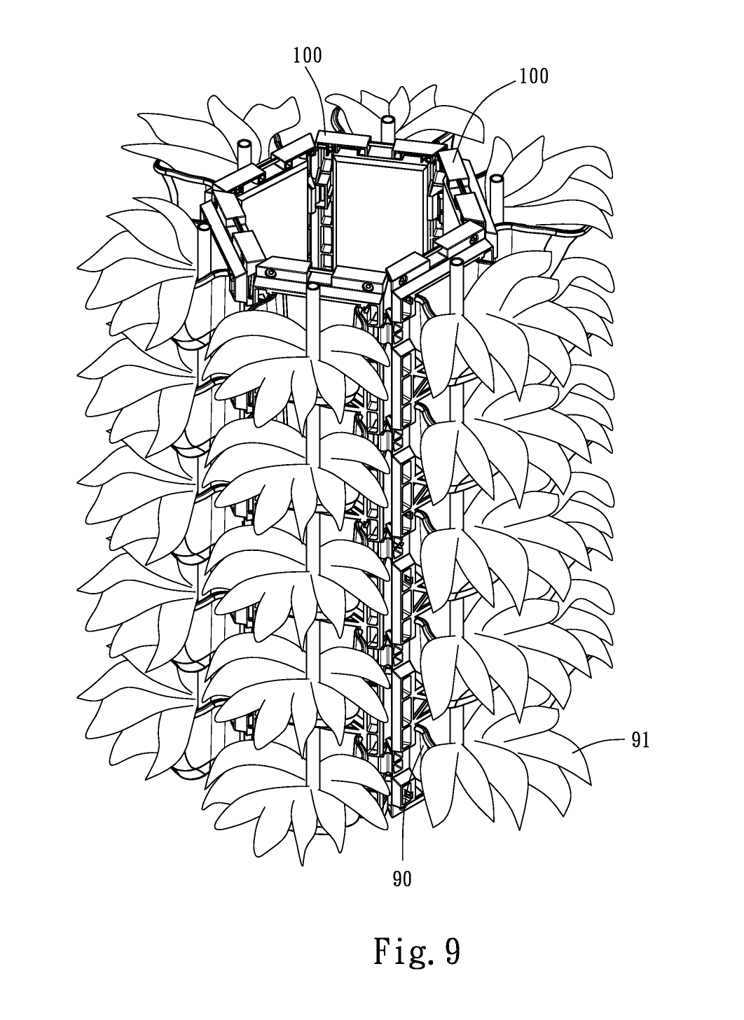

Fix garden systems 100 can be assembled to form a hexagonal structure with plants 91 placed in each flowerpot 90 (see FIG. 9).

Although the invention has been described in detail, it is to be understood that this is done by way of illustration only and is not to be taken by way of limitation. The scope of the invention is to be limited only by the appended claims.

What is claimed is:

1. A modular garden system comprising:
a rectangular frame comprising a plurality of rectangular openings spaced apart vertically;
a plurality of hooks formed on one side of the frame, each of the hooks comprising a vertical groove;
a plurality of connectors formed on an other side of the frame, each of the connectors comprising a post;
a bar disposed on a top of the frame; and
a hook member disposed on an underside of the frame, the hook member comprising a horizontal groove;
wherein the posts of one garden system are capable of being complimentarily received in the vertical grooves of the hooks of an adjacent garden system; and
wherein the bar of one garden system is capable of being complimentarily received in the horizontal groove of the hook member of an adjacent garden system.

2. The modular garden system of claim 1, wherein the frame is made of plastic.

3. The modular garden system of claim 1, wherein the vertical groove of each of the hooks has a vertical narrow opening.

4. The modular garden system of claim 1, wherein the posts are vertically oriented.

5. The modular garden system of claim 1, wherein the frame is rectangle, the hooks are equally spaced apart on one side of the frame, and the posts are equally spaced apart on an other side of the frame.

6. The modular garden system of claim 5, wherein the plurality of hooks are formed on one side of the frame, the plurality of connectors are formed on an other side of the frame, the bar is disposed on an intermediate portion of the top of the frame, and the hook member is disposed on an intermediate portion of the underside of the frame.

7. The modular garden system of claim 6, wherein the horizontal groove of each of the hook members has a horizontal narrow opening.

8. The modular garden system of claim 6, wherein the bar is horizontally oriented.
